(19) United States
(12) Patent Application Publication
(10) Pub. No.: US 2024/0368810 A1
(43) Pub. Date: Nov. 7, 2024

(54) DEVICE AND METHOD FOR DETERMINING A CLASSIFICATION OF A CURRENT PRODUCTION OUTPUT OF AT LEAST ONE OR MORE PARTS OF A SPINNING MILL

(71) Applicant: Maschinenfabrik Rieter AG, Winterthur (CH)

(72) Inventors: Nitin PATIL, Winterthur (CH); Maurizio TROGLIO, Henggart (CH); Marcel RENGEL, Winterthur (CH)

(21) Appl. No.: 18/568,032

(22) PCT Filed: Jun. 3, 2022
(86) PCT No.: PCT/IB2022/055200

§ 371 Date: Dec. 7, 2023

(30) Foreign Application Priority Data
Jun. 11, 2021 (IN) 202141026072
Sep. 30, 2021 (EP) 21200069.9

(51) Int. Cl. D01H 13/32

(52) U.S. Cl. CPC D01H 13/32

(57) ABSTRACT

An electronic device, and associated method of operation, determines a classification of a current production output of one or more parts of a spinning mill. The electronic device is configured to: determine the current production output of the spinning mill parts; determine a current configuration of the spinning mill; based on the current configuration, look up an expected production output of the spinning mill parts in a database; and determine the classification of the current production output by evaluating the current production output with respect to the expected production output for the current configuration of the spinning mill.

### FIELD OF INVENTION

The disclosure relates to a device and a method for determining a classification of a current production output of at least one or more parts of a spinning mill.

### DESCRIPTION OF RELATED ART

Spinning mills include large numbers of textile machines and other components such as transport systems, power units, air conditioning devices, etc., and are designed for converting natural and man-made fibers and their blends into desired quantities of desired yarn types having desired properties, such as quality, structure, texture, etc.

A spinning mill or subsets of a spinning mill can be configured differently in order to produce different yarns. Some configurations of the spinning mill or subsets of the spinning mill can enable production of a single yarn type at high quantities, and other configurations of the spinning mill or subsets of the spinning mill can enable production of a plurality of different yarn types at the same time, e.g. at lower quantities each. A spinning mill is often operated in work shifts of for example 8 hours, and after each work shift, or after other predetermined time periods, the configuration of the spinning mill is changed from one configuration to another configuration for respectively enabling that at the end of the work shift, or at the end of another predetermined time period, a desired total result of desired quantities of desired yarn types is completed.

During operation of a spinning mill, control devices and/or shift operators continuously monitor, control, maintain, etc. the spinning mill and/or subsets of the spinning mill, namely individual parts such as textile machines, transport systems, etc., as well as quality, quantity, etc. of intermediate or final textile materials. It is however difficult for control devices and/or shift operators to classify from this the current production output of the spinning mill, e.g. to classify if the spinning mill runs normally or abnormally. However, depending on a classification of the production output of the spinning mill or of at least one or more parts of it, control devices and/or shift operators should initiate actions, in particular for improving production output of the spinning mill or at least one part of it. Actions may include determining degraded parts of the spinning mill which may have an effect on the current production output of the spinning mill, maintenance work, configuration changes (e.g. adjusting conveyor or rotation speeds), relocation of production, etc.

WO2018055508A1 relates to predictive maintenance of a textile machine. The textile machine comprises a number of sensors. A reference value for each sensor is defined and stored in a database. During operation of the textile machine, a signal of each sensor is read and correlated with the stored reference value. An alert is given if a single sensor data or correlated sensor data show irregularities.

EP3654114A1 relates to a parameter manager for managing parameters of machines and processes in spinning mills in respect with production quality, usage of raw material, reduced waste, conversion costs, labour costs, maintenance costs and/or consumable costs as well as increase of production volume and ideal batch allocation to different machines. The parameter manager uses artificial intelligence algorithms comprising neural networks alone or in combination with case based reasoning and traditional mathematical models.

U.S. Pat. No. 5,799,476A relates to increasing operating efficiency of a spinning machine and to generating a response suitable to the hierarchy or quality of an error message in case of an error in the yarn or in another electrical or mechanical device of the spinning machine. The parameter signal of the yarn obtained by a measuring device is transmitted to an evaluating phase which emits error message signals. These are attributed in an attribute section to pre-defined error groups. Each one of the output signals of the attribution section represents a group of errors and generates (automatically) graduated responses for the elimination of errors.

U.S. Pat. No. 5,560,194A relates to optimal control of textile machinery to achieve a target operating point. A machinery model is determined which simulates a fiber processing machine. Different parameters related to the machinery and the input fibers are introduced to the model to create optimized settings for the parameters. These optimal settings are introduced to the machinery and the inputted fibers to process the fibers to achieve the desired output.

### BRIEF SUMMARY OF THE INVENTION

There is a need for a device and a method for classifying a current production output of a spinning mill or of a subset of the spinning mill. Additional objects and advantages of the invention will be set forth in part in the following description, or may be obvious from the description, or may be learned through practice of the invention.

Such a need may be met by the subject-matter of the invention as disclosed herein.

An aspect of the invention relates to an electronic device for determining a classification of a current production output of at least one or more parts of a spinning mill. The electronic device is configured to determine the current production output of the at least one or more parts of the spinning mill. The electronic device is configured to determine a current configuration of the spinning mill. The electronic device is configured to lookup, based on the current configuration, an expected production output of the at least one or more parts of the spinning mill in a database having stored a plurality of configurations of spinning mills assigned to respective expected production outputs. The electronic device is configured to determine the classification of the current production output by evaluating the current production output with respect to the expected production output.

The electronic device may relate to a control device or an operator device of a spinning mill which includes for example programs executed by a processor to provide the operations and functions of the electronic device.

A part of the spinning mill may relate to a textile machine, a set of textile machines, etc. which produce textile material at a particular production output.

The current configuration of the spinning mill may relate to a configuration of the spinning mill for producing output textile materials such as yarn of a desired quantity and/or quality during a predefined time period such as during a work shift, or during a shorter or longer time period. The current configuration may define how textile machines interoperate with each other, for example which subsequent textile machine receives the output of which previous textile machine. The current configuration may define operating parameters of textile machines such as rotation speed and other parameters.

A configuration of a spinning mill may relate to a layout of textile machines indicating e.g. which textile machine receives textile material from which textile machine for processing and/or which textile machine delivers textile material to which textile machine for further processing, to a running status of textile machines indicating e.g. if particular textile machines are running or down, to machine types of textile machines, to a number of running textile machines of a particular type, to machine parameters of textile machines indication e.g. a rotation speed, etc., to work shift information, etc. Depending on the configuration, a spinning mill or parts of the spinning mill enable a particular production output. A first configuration of a spinning mill may result in a different production output than a second configuration of the spinning mill.

The database having stored a plurality of configurations of spinning mills assigned to respective expected production outputs may relate to any ordered set of information, such as a knowledge-based database having stored configurations and expected production outputs of previously executed configurations. The current configuration of the spinning mill may relate to a subset of the spinning mill. Looking up the expected production output may relate to minimizing a distance between the current configuration of the spinning mill and the configurations stored in the database, in particular in case the current configuration does not have an exact match in the database.

Determining the classification of the current production output by evaluating the current production output with respect to the expected production output may relate to any useful set of information, such as a binary information based on a comparison with a threshold of the difference between the current and the expected production output for distinguishing between a normal current production output, e.g. a green production output, and an abnormal current production output, e.g. a red production output, or such as more complex information including time series of the current production output and the related expected production output, which enable to provide a more detailed classification of the current production output than a binary information, e.g. by graphically displaying the information on an operator terminal, or by analyzing the information with a control device of the spinning mill.

Production output of the spinning mill may relate to a quantity and/or a quality of produced textile materials. For example, production output may relate to a quantity of produced textile material expressed in kilogram per hour [kg/h]. For example, production output may relate to a quality of produced textile material defined by a hairiness coefficient.

The classification of the current production output enables taking actions for improving the production output of the spinning mill, such as adjusting a conveyor and/or rotation speeds, adjusting a configuration for a next shift, such as machine settings, staff, etc., transmitting early information to logistics and/or customers, e.g., a delay in delivery, etc.

In some embodiments, evaluating the current production output with respect to the expected production output includes determining a difference between the current production output and the expected production output, and in particular further includes comparing the difference with a threshold. Determining the difference between the current production output and the expected production output may enable classifying the current production output into different levels, such as “normal”, “below normal”, . . . , “abnormal”, wherein an operator person may be instructed to take action only in case of an “abnormal” level, and/or wherein a control device of the spinning mill may be configured to control the spinning mill in case of a level other than “normal”.

In some embodiments, evaluating the current production output with respect to the expected production output includes enabling visualizing on an operator device a time series of the current production output relative to the expected production output.

Enabling visualizing information and/or data on an operator device, such as enabling visualizing on an operator device a time series of the current production output relative to the expected production output, may include determining and transmitting respective commands and/or data from the electronic device to the operator device. The operator device is configured to receive the commands and/or data for display on the operator device.

In some embodiments, the electronic device is further configured to determine a trust level of the expected production output, and to determine the classification of the current production output depending on the trust level. The trust level may be low in case of a configuration of the spinning mill which has not be executed before, and high in case of a configuration which has been executed many times before. For example, in case of a low trust level, determining the classification of the current production output may result in a “normal” production output, wherein the same current production output may result in a “below normal” production output in case of a high trust level.

In some embodiments, evaluating the current production output with respect to the expected production output includes enabling visualizing on an operator device current and expected production outputs of individual textile materials. Individual textile materials may relate to textile materials produced by individual textile machines, either textile materials producing an intermediate textile material and/or textile machines producing the desired final textile material.

In some embodiments, evaluating the current production output with respect to the expected production output includes enabling visualizing on an operator device current and expected production outputs of individual parts of the spinning mill.

In some embodiments, the current and expected production outputs relate to a produced quantity and/or quality of a plurality of textile materials.

In some embodiments, providing the classification includes enabling visualizing a difference between the current and expected production outputs.

In some embodiments, the electronic device is further configured to initiate an alarm function depending on the determined classification. The alarm function may include sending an alarm in the form of an SMS (Short Message System), an electronic mail, etc. to an operator device such as a smartphone. The electronic device may be configured to interact with an operator device, such that an operator may perform an analysis upon receipt of an alarm.

In some embodiments, the classification relates or further relates to a subset of parts of the spinning mill, and wherein lookup of the expected production output is based on a database having stored configurations of subsets of parts of spinning mills assigned to respective expected production outputs. Production output of subsets of spinning mills can be classified, for example with higher precision, more often, etc.

In some embodiments, the electronic device is further configured to determine a plurality of classifications and to enable switching between the plurality of classifications upon detection of a manipulation of a user interface by an operator person. Production problems can be identified and/or analyzed more quickly and/or more precisely.

In some embodiments, the electronic device is further configured to update the database with information of a current configuration and its current production output. For example, the database may be updated after a predefined time period, such as a work shift. For example, the database may be updated with the production output achieved after a predefined time period, such as a work shift. For example, a trust level assigned to an expected production output stored in the database can evolve over time, and may take into account accumulation of experience, variation, etc. The electronic device may be configured to make updates to the database only after confirmation by an operator person, to update the expected production output of a particular configuration only, to store a new data record in the database, etc.

The invention also relates to a method for classifying a current production output of at least one or more parts of a spinning mill, wherein the method includes the steps executed by an electronic device of: determining the current production output of the at least one or more parts of the spinning mill, determining a current configuration of the spinning mill; looking up, based on the current configuration, an expected production output of the at least one or more parts of the spinning mill in a database having stored a plurality of configurations of spinning mills assigned to respective expected production outputs; determining the classification of the current production output by evaluating the current production output with respect to the expected production output.

In some embodiments, evaluating the current production output with respect to the expected production output includes determining a difference between the current production output and the expected production output, and in particular further includes comparing the difference with a threshold.

In some embodiments, evaluating the current production output with respect to the expected production output includes enabling visualizing on an operator device a time series of the current production output relative to the expected production output.

In some embodiments, the method further includes determining a trust level of the expected production output, and determining the classification of the current production output depending on the trust level.

### BRIEF DESCRIPTION OF DRAWINGS

The invention will be better understood with the aid of the description of an embodiment given by way of example an illustrated by the figures, in which:

FIG. 1 illustrates schematically a spinning mill according to the prior art;

FIG. 2 illustrates schematically an electronic device according to the present invention;

FIG. 3 illustrates schematically a classification of the production output of a spinning mill including a time series of the current and the expected overall production output;

FIG. 4 illustrates schematically a classification of the production output of a spinning mill including the current and the expected production output of individual produced textile materials;

FIG. 5 illustrates schematically a classification of the production output of a spinning mill including the current and the expected production output of parts of the spinning mill producing a particular textile material; and

FIG. 6 illustrates schematically possible method steps of a method for determining a classification of a current production output of a spinning mill.

### DETAILED DESCRIPTION OF THE INVENTION

Reference will now be made to embodiments of the invention, one or more examples of which are shown in the drawings. Each embodiment is provided by way of explanation of the invention, and not as a limitation of the invention. For example features illustrated or described as part of one embodiment can be combined with another embodiment to yield still another embodiment. It is intended that the present invention include these and other modifications and variations to the embodiments described herein.

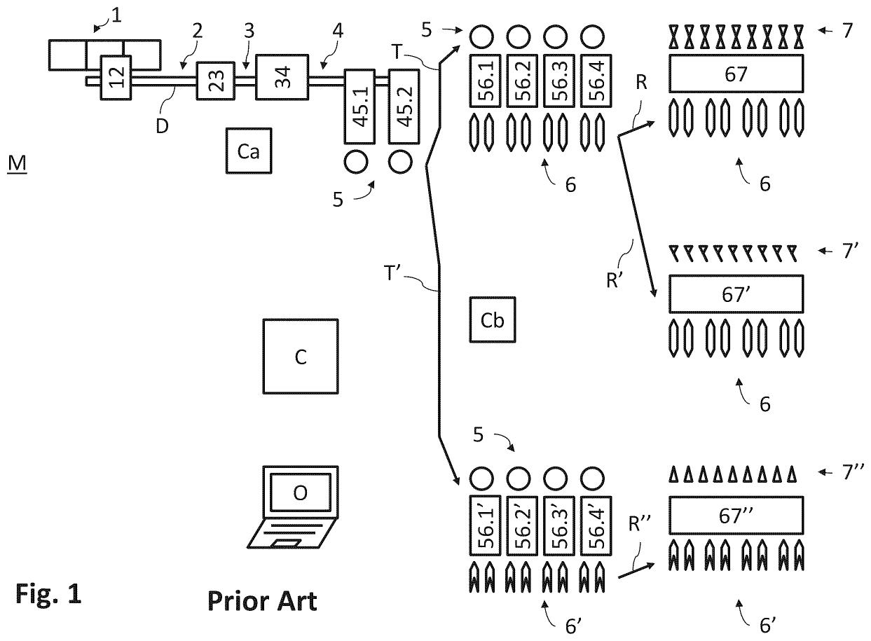

FIG. 1 illustrates schematically an exemplary spinning mill M according to the prior art. The spinning mill M comprises exemplary textile machines 12, 23, 34, 45, 56, 67, 67′, 56′, 67″ for processing input textile materials 1, 2, 3, 4, 5, 6, 6′ into output textile materials 2, 3, 4, 5, 6, 7, 7′, 6′, 7″. The spinning mill M is designed for converting natural and man-made fibers and their blends, for example input textile material 1 such as raw cotton, into desired quantities of desired output textile materials 7, 7′, 7″, for example different yarns, having desired properties, such as quality, structure, texture, etc. The spinning mill includes duct systems D, transports systems T, T′, railway systems R, R′, R″ for transporting output textile materials 2, 3, 4, 5, 6, 6′ to respective textile machines 23, 34, 45, 56, 67, 67′, 56′, 67″ for further processing. The spinning mill M may include further components (not illustrated), such as power units, air conditioning systems, etc.

The spinning mill M is configured for processing an input textile material 1, such as raw cotton, via intermediate textile materials 2, 3, 4, 5, 6, 6′ into desired output textile materials 7, 7′, 7″, such as different yarns arranged on cones. The spinning mill M includes different types of textile machines 12, 23, 34, 45, 56, 56′, 67, 67′, 67″, for example as follows. One or more blow room textile machines may be arranged for processing raw cotton into chute matt. One or more carding textile machines may be arranged for processing chute matt into carded sliver. One or more breaker draw frame textile machines may be arranged for processing carded sliver into break drawn sliver. One or more finisher draw frame textile machines may be arranged for processing break drawn sliver into finisher draw sliver. One or more flyer frame textile machines may be arranged for processing drawn sliver into roving. One or more ring frame textile machines may be arranged for processing roving into ring cops. One or more winding textile machines may be arranged for processing ring cops into yarn cones.

As illustrated in FIG. 1, the textile machines 45, 56, 56′ include subunits 45.1, 45.2, 56.1, 56.2, 56.3, 56.4, 56.1′, 56.2′, 56.3′, 56.4′, for example in order to provide a required throughput, as standby units, etc.

The spinning mill M includes one or more controllers C, Ca, Cb, . . . for monitoring, controlling, maintaining, etc. the spinning mill M, such as a master controller C, section controllers Ca, Cb, . . . , etc. The spinning mill M includes one or more operator devices O for enabling operator persons to interact with the spinning mill M, such as for monitoring, controlling, maintaining, etc. operation of the spinning mill M. The spinning mill M includes communication networks (not illustrated) for enabling data and information communication between the controllers C, Ca, Cb, . . . , the operator devices O, the textile machines 12, 23, 34, 45, 56, 67, 67′, 56′, 67″, etc. The controllers C, Ca, Cb and/or operator devices O may also be built into one or more textile machines 12, 23, 34, 45, 56, 67, 67′, 56′, 67″ or into a local central control console for controlling and/or monitoring at least a part of a spinning mill M. For example, an operating console with which at least two parallel draw frames can be monitored and controlled. Or an operating console with which several sequential machines of a blow room can be controlled and monitored.

In some embodiments, one or more controllers, C, Ca, Cb, . . . and/or one or more operator devices O may be embodied in the form of computers. Furthermore, one or more controllers C, Ca, Cb, . . . and one or more operator devices O may be included into a single computer. Such computers may relate to computers that are generally used in one place (such as conventional desktop computers, workstations, servers, etc.) or to computers that are generally portable (such as laptops, notebooks, tablets, handheld computers, etc.). The computers may include machine-readable media having stored thereon instructions which program processors of the computers to perform some or all of the operations and functions described in this disclosure. Machine-readable media may include any mechanism for storing, receiving or transmitting information in a form readable by a machine (e.g., a computer), such as Hard Disk drives (HD), Solid State Disk drives (SSD), Compact Disc Read-Only Memory (CD-ROMs), Read-Only Memory (ROMs), Random Access Memory (RAM), Erasable Programmable Read-Only Memory (EPROM), etc. The machine-readable media include instructions stored thereon, which when executed by a processor, causes the processor to perform the operations and functions on the control devices C, Ca, Cb, . . . and/or the operator devices O as described in this disclosure. In other embodiments, some of these operations and functions might be performed by fixed hardware circuit components of the controllers C, Ca, Cb, . . . and/or operator devices O that contain hardwired logic. The operations and functions might alternatively be performed by any combination of programmable computer components and fixed hardware circuit components.

The control devices C, Ca, Cb, . . . and/or the operator devices O may be configured for monitoring, controlling, maintaining, etc. the spinning mill M. The operator devices O may be configured for displaying information about the state of the spinning mill M on a display for respectively informing operator persons. Information about the state of the spinning mill M may relate to current states of parts of the spinning mill M, such as a fill level of lubricant, etc., to the current configuration of the spinning mill M, to quantity, quality, etc. of produced intermediate textile materials or output textile materials 7, 7′, 7″, etc.

The configuration of the spinning mill M illustrated in FIG. 1 is an exemplary first one of a plurality of possible configurations of the spinning mill M. For example, according to an exemplary second configuration of the spinning mill M (not illustrated), the textile machine 56′ is not in operation respectively not running and the textile machine 67″ receives input textile materials 6 from textile machine 56 instead from textile machine 56′ for producing output textile material 7″ of a different kind. The configuration of the spinning mill M does not only relate to a layout of parts of the spinning mill M, such as illustrated with the previous first and second examples, but also to a mode of operation of parts of the spinning mill M, such as rotation speeds, throughputs, etc. of textile machines. For example, in order to enable a predetermined quality level, it may be required to reduce a throughput of a textile machine.

Thus, the spinning mill M can be configured in accordance with different needs for producing desired output textile materials 7, 7′, 7″ at a desired production output. Some configurations may enable producing at the same time a plurality of output textile materials 7, 7′, 7″ at for example moderate quantities, in particular at high qualities. Other configurations may enable producing a single output textile material 7 at for example high quantities, in particular at moderate qualities.

It is however difficult for control devices C, Ca, Cb, . . . and/or operator devices O to enable a classification of a current result of a current configuration of a spinning mill M, in particular because spinning mills M include large numbers of parts, in particular large number of textile machines, and enable large numbers of different configurations.

For example, it may happen that in some configurations a degraded part of the spinning mill M may still well support achieving a desired total result of produced output textile materials 7, 7′, 7″, while in other configurations of the spinning mill the degraded part may prevent achieving the desired total result. For example, the degraded part may relate to a textile machine having a reduced throughput. For some configurations, the degraded textile machine may not be or only marginally be in operation (e.g. a ring spinning machine in which several spinning positions have stopped working) and the reduced throughput may therefore have no or little effect on the desired total result. For other configurations, the reduced throughput may prevent achieving the desired total result, because these configurations may require that the degraded textile machine is heavily in operation, wherein the degraded textile machine cannot deliver the required throughput.

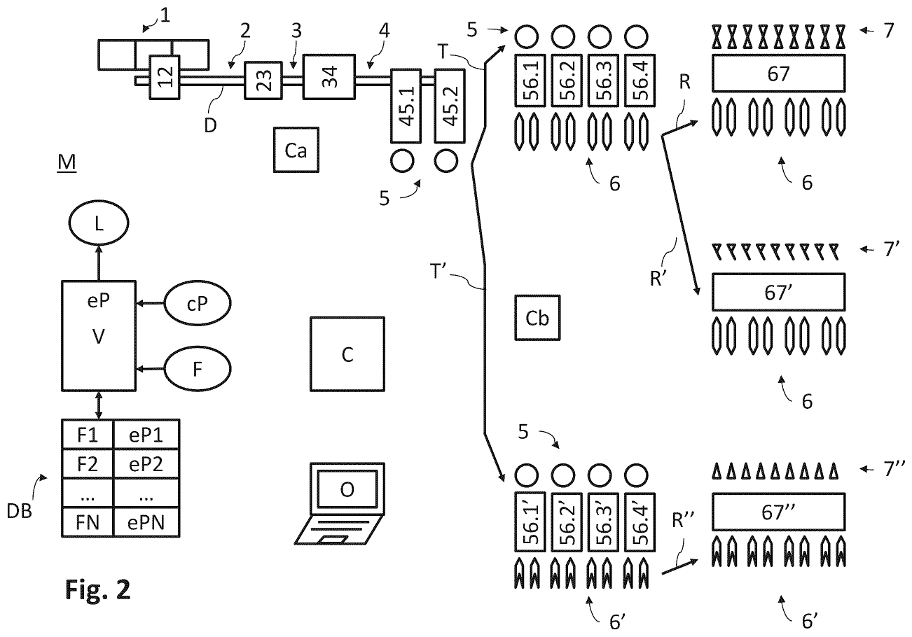

In accordance with the present invention, FIG. 2 illustrates an electronic device V for determining a classification L, La, Lb of a current production output cP of at least one part of a spinning mill M. As illustrated in FIG. 2, the electronic device V may be arranged together with a spinning mill M according to the prior art as illustrated in FIG. 1.

The electronic device V may relate to a computer as described above. Thus, the electronic device V may include one or more processors and a memory storing one or more programs configured to be executed by the one or more processors, the one or more programs including instructions for enabling various functions as described in the present disclosure. The electronic device V may be included in a controller C, Ca, Cb or an operator terminal O as described above, for example in the form of programs stored in a memory and being designed for execution by respective processors. Furthermore, the electronic device V may include one or more controllers C, Ca, Cb, . . . and/or operator terminals O as described above.

The electronic device V, e.g. a program stored in a memory of the electronic device V, is configured to determine the current production output cP of the at least one part of the spinning mill M. The electronic device V is configured to determine a current configuration F of the spinning mill M, the current configuration F being designed for execution within a predetermined time period such as a work shift for producing desired textile materials 7, 7′, 7″. The electronic device V is configured to lookup, based on the current configuration F, an expected production output eP of the spinning mill M in a database DB having stored a plurality of configurations F1, F2, . . . , FN of spinning mills M assigned to respective expected production outputs eP1, eP2, . . . , ePN. The electronic device V is configured to determine the classification L, La, Lb of the current production output cP by evaluating the current production output cP with respect to the expected production output eP. Good results may be achieved if the database DB is a cloud database that can be accessed by multiple spinning mills.

The current configuration F may be stored in a controller C, Ca, Cb of the spinning mill M and may relate to a predetermined time period such as a work shift which starts at a time to and ends at a time t1, for example. The total time of the predetermined time period such as a work shift may be 8 hours, for example. The predetermined time period may relate to shorter or longer time periods, such as 2 hours, 4 hours, 12 hours, 16 hours, etc. The current configuration F enables the spinning mill M to produce during a predefined time period such as a work shift desired output textile materials 7, 7′, 7″ at desired quantities and/or qualities.

The database DB having stored a plurality of configurations F1, F2, . . . , FN of spinning mills M assigned to respective expected production outputs eP1, eP2, . . . , ePN may relate to any organized collection of data. The configurations F1, F2, . . . , FN of spinning mills may relate to particular layouts of spinning mills, wherein each part of a respective spinning mill is operated at specific operation modes. A possible configuration of a spinning mill M is illustrated in FIG. 1, 2, wherein textile materials are transported from one textile machine to another textile machine according to a predefined layout, and wherein the textile machines are operated at predetermined operation modes, such as regards a rotation speed, throughput, etc. The database DB has stored for each configuration F1, F2, . . . , FN a respective expected production output eP1, eP2, . . . , ePN. The expected production outputs eP1, eP2, . . . , ePN may relate to a total quantity of produced output textile materials 7, 7′, 7″, for example. The expected production outputs eP1, eP2, . . . , ePN may relate to an expected quantity of each one of the produced output textile materials 7, 7′, 7″. The expected production outputs eP1, eP2, . . . , ePN may relate to an expected quantity of a produced output textile material 7″ produced at subunits 67.1″, 67.2″, 67.3″, 67.4″, 67.5″ (not shown in FIG. 1, 2) of a textile machine 67″.

Quantities of textile materials 7, 7′, 7″ may relate to kg/h (kilogram per hour) or m/s (meter per second).

The expected production output eP and the current production output cP may relate to relative values expressed as percentages, normalized values, etc.

Looking up the expected production output eP in the database DB may include determining from the stored configurations F1, F2, . . . , FN a configuration Fx which matches as close as possible the current configuration F, in particular in case the database DB does not include a stored configuration F1, F2, . . . , FN with an identical match to the current configuration F, for example by minimizing a distance between the current configuration F and the stored configurations F1, F2, . . . , FN.

The electronic device V may be further configured to determine a trust level TL of the expected production output eP, and to determine the classification L, La, Lb of the current production output depending on the trust level TL. For example, one or more expected production outputs eP1, eP2, . . . , ePN may have assigned respective trust levels TL1, TL2, . . . , TLN, for example in the form of respective numbers. For example, higher numbers representing higher trust levels may be assigned to expected production outputs eP1, eP2, . . . , ePN of often executed and well-established configurations F1, F2, . . . , FN, and lower numbers representing lower trust levels may be assigned to expected production outputs eP1, eP2, . . . , ePN of less frequently executed and less established configurations F1, F2, . . . , FN. Thus, the trust level TL of the expected production output eP may be determined when looking up the current configuration F in the database DB. When determining the classification L, La, Lb of the current production output cP, the trust level TL of the expected production output eP is taken into account. For example, the classification L, La, Lb may include tolerance details related to the trust level, in particular indicating a larger tolerance for deviating from nominal values in case of a lower trust level TL than in case of a larger trust level TL. Evaluating the current production output cP with respect to the expected production output eP for determining a classification of the current production output cP may include determining a difference between an expected quantity and a current quantity of produced output textile materials 7, 7′, 7″. The difference may relate to a difference at a current time, or to an estimation of a difference which has to be expected at the end of a predefined time period, such as at the end of a work shift. Evaluating the current production output with respect to the expected production output eP may include comparing the difference between the current production output cP and the expected production output eP with a threshold. For example, if the difference exceeds a threshold, the electronic device V may be configured to initiate one or more actions, such as modifying a mode of operation of the spinning mill M, executing an alarm function, etc.

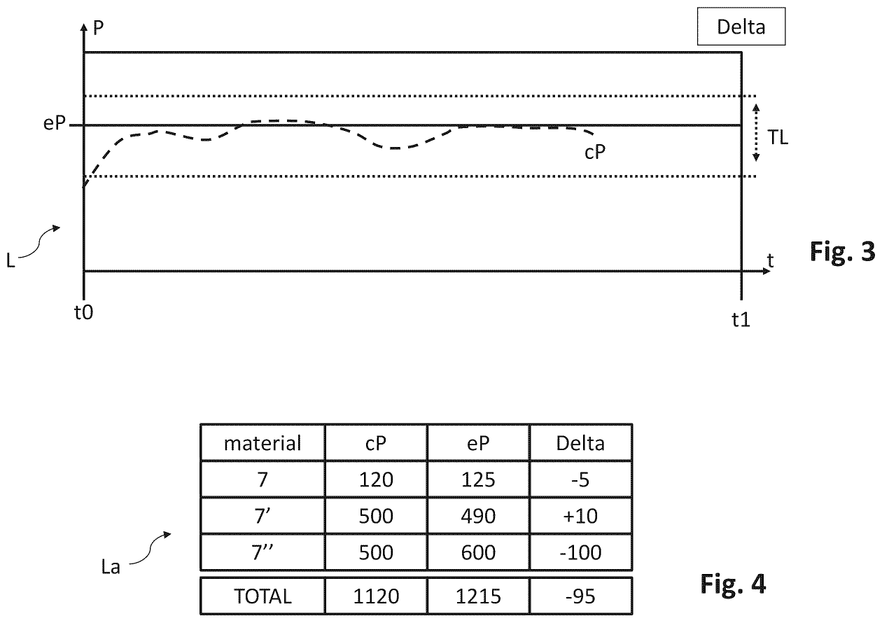

FIG. 3 illustrates schematically determining a classification L of the current production output cP by evaluating the current production output cP with respect to the expected production output eP by enabling visualizing on an operator device O a time series of the current production output cP relative to the expected production output eP. As illustrated in FIG. 1, at initial time to, for example at the beginning of a work shift, the current configuration F of the spinning mill M is determined, and by lookup in the database DB, the expected production output eP is determined. Furthermore, a trust level TL of the expected production output eP may be determined as described above. The expected production output eP may relate to the total quantity of the sum of output textile materials 7, 7′, 7″. The current production output cP of the spinning mill is measured accordingly on the basis of respective sensors arranged at textile machines 67, 67′, 67″. After initial time to, the current production output cP, e.g. the sum of the quantities of currently produced output textile materials 7, 7′, 7″ is visualized in the form of a time series displayed with respect to the expected production output eP. Thus, operator persons have access to a classification of the current production output cP of the spinning mill M, and can initiate actions if the difference between the current production output cP and the expected production output is not acceptable. Furthermore, depending on the trust level TL of the expected production output eP, if applicable, tolerance details may be included in the classification L of the current production output cP in the form of tolerance details related to the trust level TL, which tolerance details include an indication about how much the current production output cP may deviate from the expected production output eP.

FIG. 4 illustrates schematically determining a classification La of the current production output cP by evaluating the current production output cP with respect to the expected production output eP by enabling visualizing on an operator device O current and expected production outputs cP, eP of individual textile materials 1, 2, 3, 4, 5, 6, 6′, 7, 7′, 7″, in particular of individual output textile materials 7, 7′, 7″. Contrary to FIG. 3, which visualizes the sum of the production output of produced output textile materials 7, 7′, 7″ for each one of the produced output textile materials 7, 7′, 7″, the current production output cP and the expected production output eP, respectively the current quantity and the expected quantity of produced textile materials, is visualized. Thus, if the classification L according to FIG. 3 indicates a problem with the current production output, the operator persons have access to a classification Lb of the current production output cP which enables initiating actions more precisely. As indicated in FIG. 4, no action seems likely to be necessary as regards textile machines 67, 67′ producing textile materials 7, 7′ at expected production outputs eP, wherein actions to be taken seem more likely as regards textile machine 67″ producing output textile material 7″ at below than expected production output eP.

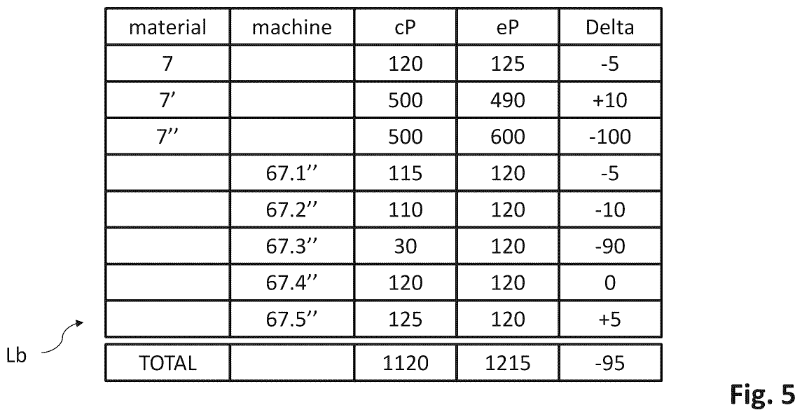

FIG. 5 illustrates schematically determining a classification Lb of the current production output cP by evaluating the current production output cP with respect to the expected production output eP by enabling visualizing on an operator device O current and expected production outputs cP, eP of individual parts 67.1″, 67.2″, 67.3″, 67.4″, 67.5″ of the spinning mill M, in particular of subunits of a particular textile machine 67″ producing output textile material 7″. Contrary to FIG. 4, which visualizes the current production output La of a textile machine 67″, for each part 67.1″, 67.2″, 67.3″, 67.4″, 67.5″ of the textile machine 67″ the current production output cP and the expected production output eP, respectively the current quantity and the expected quantity of produced textile materials, is visualized. Thus, if the classification La according to FIG. 4 indicates a problem with the current production output of textile machine 67″, the operator persons have access to a classification Lb of the current production output cP which enables initiating actions more precisely. As indicated in FIG. 5, no actions seem likely to be necessary as regards parts (or subunits) 67.1″, 67.2″, 67.4″, 67.5″ of textile machine 67″ producing textile material 7″ at expected production outputs eP, wherein actions to be take seem more likely as regards part (or subunit) 67.3″ producing output textile material 7″ at below than expected production output eP.

The electronic device V, for example in cooperation with an operator terminal O, may be configured to enable an operator person to switch between any of the classifications L, La, Lb according to FIG. 3, 4, 5. For example, in case the classification L according to FIG. 3 indicates a below than normal production output, it may be enabled that the operator may switch to the classification La according to FIG. 4 by manipulating a user interface of the operator terminal O, such as by clicking on the current production output cP visualized in FIG. 3. Furthermore, if the classification La according to FIG. 4 indicates a below than normal production output, by respective manipulation, e.g. by clicking on the visualization of the current and expected production output cP, eP of textile material 7″, it may be enabled that the operator person may switch to the classification Lb according to FIG. 5. Accordingly, the operator person is enabled to quickly and precisely determine which actions seem necessary or likely for improving the production output of the spinning mill M.

Furthermore, the electronic device V, and/or control devices C, Ca, Cb, and/or operator terminals O may be configured to determine actions to be taken by automatically evaluating the classifications L, La, Lb as illustrated in FIG. 3, 4, 5, and to initiate such actions automatically, or after confirmation by an operator person, etc.

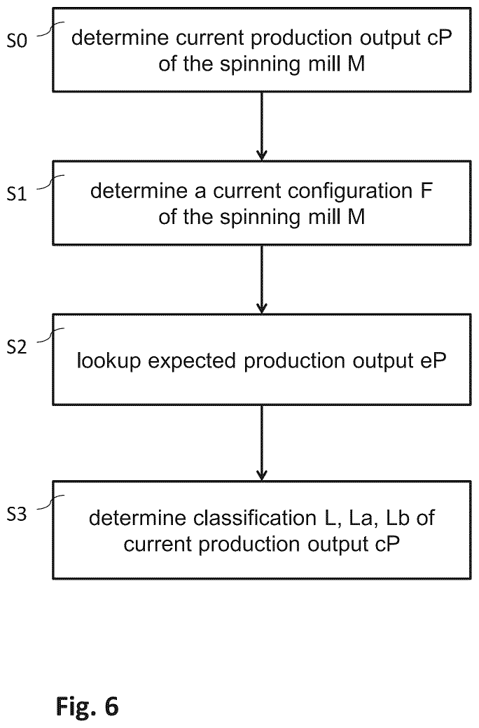

FIG. 6 illustrates schematically possible method steps of a method for determining a classification L, La, Lb of a current production output cP of a spinning mill M. In step SO, the current production output cP of the at least one or more parts of the spinning mill M is determined, In step S1, a current configuration F of the spinning mill is determined. In step S2, the expected production output eP of the spinning mill M is looked up in a database DB having stored a plurality of mill configurations F1, F2, . . . , FN and respective expected production outputs eP1, eP2, . . . , ePN. In step S3, a classification L, La, Lb of the current production output cP is determined by evaluating the current production output cP with respect to the expected production output eP.

### REFERENCE NUMERALS/SIGNS

M spinning mill
1,2,3,4,5,6,6′,7,7′,7″ textile materials
12,23,34,45,56,56′,67,67′,67″ textile machines
D duct system
T, T′ trolley systems
R, R′, R″ rail systems
C, Ca, Cb control devices
O operator device
V electronic device
F current configuration of the spinning mill
DB database with stored configurations assigned to expected production outputs
F1, F2, . . . , FN stored configurations of spinning mills
eP1, eP2, . . . , ePN stored expected production outputs
TL1, TL2, . . . , TLN trust levels of stored expected production outputs
eP expected production output of current configuration of the spinning mill
TL trust level of expected production output
cP current production output of current configuration of the spinning mill
L, La, Lb classification of current production output

1-15. (canceled)

16. An electronic device that determines a classification of a current production output of one or more parts of a spinning mill, the electronic device being configured to:
determine the current production output of the one or more parts of the spinning mill;
determine a current configuration of the spinning mill;
based on the current configuration, look up an expected production output of the one or more parts of the spinning mill in a database, the database having stored therein a plurality of configurations of the spinning mill and the respective expected production outputs assigned thereto; and
determine the classification of the current production output by evaluating the current production output with respect to the expected production output for the current configuration of the spinning mill.

17. The electronic device of claim 16, further configured to determine a difference between the current production output and the expected production output and compare the difference to a threshold difference value.

18. The electronic device of claim 16, further configured to provide on an operator device a visual display of a time series of the current production output relative to the expected production output.

19. The electronic device of claim 16, further configured to determine a trust level of the expected production output, and to determine the classification of the current production output depending on the trust level.

20. The electronic device of claim 16, further configured to provide on an operator device a visual display of current and expected production outputs of a plurality of individual textile materials produced in the spinning mill.

21. The electronic device of claim 16, further configured to provide on an operator device a visual display of current and expected production outputs of a plurality of individual parts of the spinning mill.

22. The electronic device of claim 16, wherein the current and expected production outputs relate to one or both of a produced quantity and a quality of a plurality of textile materials produced in the spinning mill.

23. The electronic device of claim 16, further configured to provide on an operator device a visual display of a difference between the current and expected production outputs.

24. The electronic device of claim 16, further configured to initiate an alarm function depending on the determined classification.

25. The electronic device of claim 16, wherein the classification relates to a subset of parts of the spinning mill, the electronic device further configured to lookup the expected production output of the subset of parts in the database, wherein the database further includes configurations of subsets of parts of the spinning mill and the respective expected production outputs assigned thereto.

26. The electronic device of claim 16, further configured to determine a plurality of the classifications and to enable switching between the plurality of classification upon detection of a manipulation of a user interface by an operator person.

27. The electronic device of claim 16, further configured to update the database with information of the current configuration and the current production output.

28. A method executed by an electronic device for classifying a current production output of one or more parts of a spinning mill, the method comprising:
determining the current production output of the one or more parts of the spinning mill;
determining a current configuration of the spinning mill (M);
based on the current configuration, look up an expected production output of the one or more parts of the spinning mill in a database, the database having stored therein a plurality of configurations of the spinning mill and the respective expected production outputs assigned thereto; and
determining the classification of the current production output by evaluating the current production output with respect to the expected production output for the current configuration of the spinning mill.

29. The method of claim 28, wherein evaluating the current production output with respect to the expected production output includes determining a difference between the current production output and the expected production output and comparing the difference to a threshold difference value.

30. The method of claim 28, wherein evaluating the current production output with respect to the expected production output includes enabling visualizing on an operator device a time series of the current production output relative to the expected production output.
